(19) United States
(12) Patent Application Publication
(10) Pub. No.: US 2018/0346752 A1
(43) Pub. Date: Dec. 6, 2018

(54) WATERBORNE COATING FOR SYNTHETIC PAPER

(71) Applicant: NAN YA PLASTICS CORPORATION, Taipei (TW)

(72) Inventors: Te-Chao LIAO, Taipei (TW); Sen-Huang HSU, Taipei (TW); Chih-Hao HUANG, Taipei (TW)

(21) Appl. No.: 15/990,874

(22) Filed: May 29, 2018

(30) Foreign Application Priority Data
May 31, 2017 (TW) 106117968

(51) Int. Cl. C09D 133/10; C09D 7/61; C09D 7/65; C09D 7/40; D21H 19/20; D21H 19/64; D21H 21/14; D21H 21/54

(52) U.S. Cl. CPC C09D 133/10; C09D 7/61; C09D 7/65; C09D 7/68; C09D 7/69; C09D 125/04; D21H 19/20; D21H 19/64; D21H 21/14; D21H 21/54; C09D 7/70

(57) ABSTRACT

A waterborne coating consists in an ink-absorbing spheres emulsion containing acrylate micro-sphere formed with a hollow chamber, an inorganic ink-absorbing material worked with the ink-absorbing spheres emulsion together for use in absorbing ink, a waterborne acrylate emulsion containing a low-Tg acrylate monomer liquid to fix the inorganic ink-absorbing material, and a waterborne crosslinker having two or more reactive functional groups to bridge with carboxyl monomers; and particularly the waterborne coating is coated onto synthetic paper as a surface coating to endow the synthetic paper with good printability, coating adhesion, water resistance, scrape resistance and solvent resistance.

### BACKGROUND OF THE INVENTION

### 1. Field of the Invention

The present invention relates to a waterborne coating, and more particularly to a waterborne coating for use in synthetic paper to have good printability and water resistance.

### 2. Description of Related Art

Natural wood pulp paper is not waterproof, and tends to be scratched, so its usage is limited. A kind of laminated synthetic polyolefin paper has been developed as a substitute for the natural wood pulp paper. The synthetic polyolefin paper structurally has a layer of biaxially stretched polypropylene film as its intermediate substrate, on which a layer of polypropylene film that contains inorganic salt powder and has been uniaxially stretched is attached or coated as its paper surface. Such synthetic polyolefin paper advantageously has good water resistance and tearing strength. However, its plastic surface has relatively low capacity of absorbing ink (hereinafter referred to as ink absorptivity) when printed, so the existing synthetic polyolefin paper is not ideal in terms of ink printing effect (hereinafter referred to as printability).

For improving the printability of synthetic polyolefin paper for gravure, a known approach involves applying acrylate copolymer emulsion or polyethylenimine emulsion on the surface of synthetic paper as an ink-absorbing material, whose amount of coating dosage is ranged between 0.005 and 0.1 g/m². However, such existing synthetic paper requires more time for ink drying, so it is not suitable for printing or writing.

Another known kind of synthetic polyolefin paper features addition of calcium carbonate as its bulking agent to improve the biaxially stretched polypropylene film working as the intermediate substrate by making it have micropores. Besides, for improving ink absorptivity, the biaxially stretched polypropylene film is coated with a layer of 10 μm coating as its ink-absorbing surface coating whose composition by weight includes 8-20 wt % of acrylic resin, 20-60 wt % of calcium carbonate, 0.1-5 wt % of white clay, 0.1-2 wt % of titanium dioxide, 30-90 wt % of water, and 0-2 wt % of antistatic agent.

With the micropores, this synthetic polyolefin paper has its surface very similar to natural wood pulp paper, and facilitates quick drying of inks printed thereon. Nevertheless, since the surface coating of this known synthetic polyolefin paper contains hydrophilic acrylate resin, it tends to swell up when absorbing water, and such swell can adversely affect coating adhesion between the surface coating and the biaxially stretched polypropylene film that acts as the intermediate substrate. Thus, this known synthetic polyolefin paper is disadvantageous for low water resistance and weak coating adhesion, and its printed surface is vulnerable.

Another known kind of synthetic polyolefin paper improves coating adhesion by adding an aziridine-based crosslinker for surface treatment, so its surface coating has enough strength and stability to prevent the surface coating from coming off during printing (hereinafter referred to as “pull-up”). However, this known kind of synthetic polyolefin paper still leaves the problems of acrylate resin about low ink absorptivity and permeability unsolved, and thus has poor color saturation when printed.

### SUMMARY OF THE INVENTION

For addressing the foregoing problems, the primary objective of the present invention is to provide a waterborne coating that has excellent water resistance, coating adhesion and ink absorptivity. When applied to synthetic paper, the waterborne coating can receive letterpress, photogravure and screen printing, and endows synthetic paper with good water resistance, coating adhesion, ink absorptivity, printability, and color saturation when printed.

Another primary objective of the present invention is to provide a waterborne coating composition for coating synthetic paper. The composition contains special ink-absorbing spheres and an inorganic ink-absorbing material, so can speed up ink absorption and improve color saturation when the synthetic paper is printed, and with the specific waterborne acrylate and crosslinker, the composition can solve the problems of the existing synthetic paper about fouling, scrapes and pull-up when wetted, and also solve the problem about low alcohol resistance of the acrylate material.

Still another objective of the present invention is to provide a waterborne coating composition, composed of the following components 1)-4) summing up to 100 wt %, based on a total weight of the waterborne coating composition:
1) an ink-absorbing sphere emulsion taking up 2-7 wt %;
2) a waterborne acrylate emulsion taking up 26-70 wt %; wherein the waterborne acrylate emulsion is composed of the following monomers a)-d) through emulsion polymerization, with the total weight of all the reactive monomers summing up 100 wt %:
   a) an acrylate having a low lass transition temperature (hereinafter referred to as the low-Tg acrylate) taking up 45-70 wt %;
   b) hydrophobic alkyl methacrylate taking up 0.1-10 wt %;
   c) a hydrophobic styrene-based monomer taking up 10-45 wt %;
   d) a carboxyl-containing vinyl monomer taking up 1-20 wt %;
3) an inorganic ink-absorbing material taking up 26-70 wt %; and
4) a waterborne crosslinker taking up 0.5-3 wt %.

Yet still another objective of the present invention is to provide a process for producing an ink-absorbing sphere emulsion, comprising the following steps:
(A) taking a weight ratio of a methacrylic acid (MAA) monomer to a methyl methacrylate (MMA) monomer is 1:2, adding therein a butyl acrylate (BA) as an acrylate-acid monomer with a use amount equal to 6-8 times of the weight of the methyl methacrylate monomer, adding therein sodium lauryl sulfate as an anionic emulsifier with a use amount not exceeding 0.005 time of the weight of the BA monomer, and performing emulsion polymerization with the stirring speed, dropwise adding speed and time controlled, to obtain Emulsion A;
(B) taking Emulsion A, the MAA monomer and the BA monomer, wherein the use amount of the MAA monomer is 1-5 times of Emulsion A, and the use amount of the BA monomer is 1-4 times of Emulsion A, adding ethylene glycol dimethacrylate in a use amount of 0.1-2 mol % of the total amount of the monomers, and performing emulsion polymerization, to obtain Emulsion B; and
(C) taking Emulsion B and a styrene (SM) monomer with a use amount of 0.5-1.5 times of Emulsion B for emulsion polymerization, and adding ammonia, to obtain an ink-absorbing sphere emulsion provided with an unify particle size of the ink-absorbing spheres, wherein Emulsion B takes up 8.0-9.8% of the total solid content weight.

The methyl methacrylate monomer and the butyl acrylate monomer may alternatively be an acrylate-based monomer, including one or more selected from the group consisting of methyl acrylate monomer, methyl methacrylate monomer, ethyl acrylate monomer, butyl acrylate monomer and 2-ethylhexyl acrylate monomer.

The ink-absorbing spheres in the emulsion are acrylate micro-spheres, preferably having a particle size of 500-1100 nm. In the process of reaction (A), the stirring speed and the use amount of the emulsifier affect the particle size significantly. By controlling dropwise adding speed and time for material feeding, the desired particle size can be achieved.

### DETAILED DESCRIPTION OF THE INVENTION

The waterborne coating composition disclosed by the present invention has excellent water resistance, adhesion, and ink absorptivity, and is used as surface coating of synthetic paper. The composition by weight contains the following components 1)-4) summing up to 100 wt %:

1) an ink-absorbing sphere emulsion taking up 2-7 wt %;
2) a waterborne acrylate emulsion taking up 26-70 wt %;
3) an inorganic ink-absorbing material taking up 26-70 wt %; and
4) a waterborne crosslinker taking up 0.5-3 wt %.

### Ink-Absorbing Sphere Emulsion

The ink-absorbing sphere emulsion is an acrylate micro-spheres emulsion and is one of the key technologies behind the disclosed waterborne coating composition. The acrylate micro-spheres working as ink-absorbing spheres in the emulsion have an average particle size of between 0.5 and 1.1 μm, and each have a hollow chamber. During printing, printing ink can flow into and fill up the chambers of the ink-absorbing spheres under the capillary action, so the resulting color intensity is enhanced, thereby presenting vivid and saturated colors.

A process for producing the ink-absorbing sphere emulsion of the present invention includes the following steps:
1. taking a methacrylic acid (MAA) monomer to a methyl methacrylate (MMA) monomer in a weight ratio of 1:2, adding therein an acrylate-acid monomer, such as butyl acrylate (BA), with a use amount equal to 6-8 times of the weight of the methyl methacrylate monomer, adding therein sodium lauryl sulfate as an anionic emulsifier with a use amount not exceeding 0.005 time of the weight of the acrylate-acid monomer, and, after an initiator being added, performing emulsion polymerization with the stirring speed, dropwise adding speed and time controlled, so as to obtain Emulsion A;
2. taking Emulsion A, the methacrylic acid (MAA) monomer and the acrylate-based monomer, wherein the use amount of the methacrylic acid (MAA) monomer is 1-5 times of Emulsion A, and the use amount of the acrylate-based monomer is 1-4 times of Emulsion A, adding ethylene glycol dimethacrylate in the use amount of 0.1-2 mol % of the total amount of the monomers, and, after an initiator being added, performing emulsion polymerization, so as to obtain Emulsion B; and
3. taking Emulsion B and a styrene (SM) monomer with a use amount of 0.5-1.5 times of Emulsion B for emulsion polymerization, and adding ammonia, so as to obtain an ink-absorbing sphere emulsion with an average particle size of the ink-absorbing spheres ranged between 0.5 and 1.1 μm, wherein Emulsion B takes up 8.0-9.8% of the total solid content weight.

### Inorganic Ink-Absorbing Material

The inorganic ink-absorbing material is in the form of inorganic particles having pores and large surface area, with an average particle size of between 1.2 and 5 μm. It is also one of the key technologies behind the disclosed waterborne coating composition, and helps to accelerate ink absorption of the disclosed waterborne coating composition.

The inorganic ink-absorbing material having a particle diameter 1.2-5 μm and is one or more selected from the group consisting of calcium carbonate, titanium dioxide, diatomaceous earth, white clay, calcium oxide, silicon dioxide and barium sulfate, preferably is a calcium carbonate or a silicon dioxide.

The inorganic ink-absorbing material is for example to be a calcium carbonate. In this case, the disclosed waterborne coating composition uses large calcium carbonate particles (having a diameter of 1.2-5 μm) and small ink-absorbing spheres (having diameter of 0.5-1.1 μm) are nixed to achieve the optimal filling rate of the ink-absorbing spheres. During printing, ink can is fast guided into the chambers of the ink-absorbing spheres through the intervals between the calcium carbonate particles on the coating layer of synthetic paper, so the disclosed waterborne coating composition can achieve fast ink absorption and high color saturation.

### Waterborne Crosslinker

The waterborne crosslinker (also referred to as the bridging agent) used in the present invention has two or more reactive functional groups, and can bridge with reactive monomers (such as carboxyl monomers).

The waterborne crosslinker is one or more selected from the group consisting of isocyanate-containing crosslinker, epoxy-containing crosslinker and aziridine-containing crosslinker; preferably is an aziridine-containing crosslinker, such as a CX-100 bridging agent is a 100% active polyfunctional aziridine liquid crosslinker (containing three aziridine functional groups) and commercially available from DSM NeoResins Inc. Wilmington, Mass., USA.

### Waterborne Acrylate Emulsion

The waterborne acrylate emulsion used in the present invention is composed of the following four monomers a1)-a4) through emulsion polymerization, and the total weight of all the reactive monomers sum up to 100 wt %:
a1) an acrylate-based monomer having a low glass transition temperature (hereinafter referred to as low Tg acrylate monomer) taking up 45-70 wt %;
a2) a hydrophobic alkyl methacrylate monomer taking up 0.1-10 wt %;
a3) a hydrophobic styrene-based monomer taking up 10-45 wt %; and
a4) a carboxyl-containing vinyl monomer taking up 1-20 wt %.

### Low-Tg Acrylate Monomer

The polypropylene film acting as the intermediate substrate of synthetic paper can have numerous micropores after biaxially stretched. The disclosed coating composition features the low-Tg acrylate monomer. When the coating composition is applied to synthetic paper to form a paper coating layer, the acrylate monomer can easily move into the pores of the polypropylene film and anchor the coating, thereby ensuring outstanding coating adhesion of the resulting coating layer.

The low-Tg acrylate monomer of the present invention serves to enhance adhesion between the coating layer and the substrate of the synthetic paper, and is one or more selected from the group consisting of ethyl acrylate, n-propyl acrylate, n-butyl acrylate, isobutyl acrylate, and isooctyl acrylate.

### Hydrophobic Alkyl Methacrylate Monomer

The hydrophilic or hydrophobic nature of resin may be set by adjusting the proportions of hydrophilic monomers and hydrophobic monomers. The more hydrophobic the resin is, the lower the water absorption of the coating film is. When the disclosed waterborne coating composition is applied to synthetic paper to form coating film, the hydrophobic alkyl methacrylate monomer contained therein prevents water from entering the coating film of the synthetic paper so as to protect the coating film from collapse.

The hydrophobic alkyl methacrylate monomer is one or more selected from the group consisting of methyl methacrylate (MMA), ethyl acrylate (EA), propyl acrylate (PA), butyl acrylate (BA), isobutyl acrylate (IBA), amyl (meth)acrylate, hexyl methacrylate, heptyl methacrylate, 2-ethylhexylacrylate (2-HEA), n-octyl methacrylate, iso-octyl methacrylate (IOA), nonyl methacrylate (NA), sunflower methacrylate, lauryl (meth)acrylate (LA), octadecyl methacrylate, methoxyethyl (meth)acrylate (MOEA), n-butyl methacrylate (n-BMA), 2-ethylhexyl acrylate (2-EHA) and ethoxymethyl (meth)acrylates (EOMAA).

### Hydrophobic Styrene-Based Monomer

When the disclosed waterborne coating composition is applied to synthetic paper to form coating film, the hydrophobic styrene-based monomer contained therein enhances cohesive force and hydrophobe of the coating film. In addition, the coating film on the synthetic paper possesses excellent scrape resistance when immersed in water due to the polar difference between the high molecules of the monomers and water molecules.

The hydrophobic styrene-based monomer is one or more selected from the group consisting of styrene monomer (SM), methylstyrene monomer (MSM) and vinyl toluene monomer.

### Carboxyl-Containing Vinyl Monomer

When the disclosed waterborne coating composition is applied to synthetic paper to form coating film, the inorganic ink-absorbing material contained largely therein tends to settle to the lower layer of the coating film, and since the inorganic ink-absorbing material is less compatible to the resin, intervals are formed between the resin and the inorganic ink-absorbing material. These are unfavorable to binding between the resin and the inorganic ink-absorbing material.

For solving this problem, the carboxyl-containing vinyl monomer is added. Since the inorganic ink-absorbing material (such as calcium carbonate) in the composition is positively charged, the molecular chain of the carboxyl-containing vinyl monomer negatively charged can bind thereto, so as to stably disperse the inorganic ink-absorbing material over the coating film, thereby improving and strengthening binding between the inorganic ink-absorbing material and the resin, and endowing the coating film with excellent scrape resistance and preventing from pull-up.

Moreover, the disclosed waterborne coating composition contains the hydrophilic monomer. After the composition is applied to the synthetic paper to form coating film, once the hydrophilic monomer absorb water, it can make the coating film swell up and become structurally loosened. In this case, when two of such wet synthetic paper pieces are pressed onto each other, the high molecular chains of the coating films of the two pieces of synthetic paper tend to foul each other due to their lessened structures. As a solution to this problem, crosslink between the crosslinker and the carboxyl groups of the carboxyl-containing vinyl monomer can fix the high molecular chains in the coating film, and net the high molecules in the coating film, so as to prevent fouling between the molecular chains and improve anti-fouling ability of the synthetic paper after immersed into water.

The carboxyl-containing vinyl monomer is one or more selected from the group consisting of acrylic acid (AA), methacrylic acid (MAA), maleic anhydride (MA), fumaric acid (FA), itaconic acid (IA), butenoic acid (BA) and maleic anhydride (MAH).

### Emulsifier

Selection of the emulsifier is the most important part of the emulsion polymerization action, and can affect the following matters:
(1) the molecular weight of the polymer, the polymerization speed and the conversion rate;
(2) the polymer particle size in the emulsion;
(3) the physical properties of the coating film; and
(4) the stability of the emulsion.

The emulsifier used in the present invention is added in two stages. The use amount of the initiatory emulsifier for the first stage is 1-2.3 wt % of the total reactive monomers, and in the second stage the emulsifier equal to 1.0-2.5 wt % of the total reactive monomers is added into all the reactive monomers to form a pre-emulsion. The two-stage addition of the emulsifier contributes to evener and faster emulsion polymerization.

The reactive emulsifiers used in the present invention are structurally characterized by carbon-carbon double bonds and can be classified into two types, namely anion emulsifiers and non-ionic emulsifiers. Alternatively, according to the present invention, it is feasible to use a combination of anion emulsifiers and non-ionic emulsifiers.

### Anionic Emulsifier

Reactive anion emulsifiers are exemplified by PC-10 of Sanyo Chemical Industries, Ltd.; MS-2N of Sino-Japan Chemical; NOIGEN RN-20, RN-30, RN-50 of Chin-Yee Chemical Industries Co., Ltd.; SDBS95 of Big Sun Chemical Corporation; Maxmul-6112 of Ching Tide, LATEMUL PS or LATEMUL ASK of Kao (Taiwan) Corporation, and non-reactive emulsifier NP6SF or SDS of Jiuh Yi Chemical Industrial Co., Ltd.

### Non-Ionic Emulsifiers

Reactive non-ionic emulsifiers are exemplified by 5010 of Ching Tai and E950 of Sino-Japan Chemical.

### Initiator for Synthesizing Waterborne Resin

Most of the initiators used in emulsion polymerization are water-soluble, and the initiator in one or more selected from the group consisting of hydrogen peroxide (H₂O₂), sodium persulfate (Na₂S₂O₈), ammonium persulfate ((NH₄)₂S₂O₈), and potassium persulfate (K₂S₂O₈) and azobisisobutyronitrile (AIBN).

The reducing agents used in emulsion polymerization are, namely sodium bissulfite (NaHSO₃), sodium metabissulfite (Na₂S₂O₅) or sodium hydrosulfite (Na₂S₂O₄).

### Preparation of Waterborne Coating

The disclosed waterborne coating is prepared using the foregoing waterborne coating composition to form a coating film or coating layer on the surface of synthetic paper. The process for preparing the waterborne coating comprises steps of:
1) well mixing water and the crosslinker;
2) adding the waterborne acrylate emulsion and stirring;
3) adding the ink-absorbing spheres to well mix with the inorganic ink-absorbing materials, and
4) filtering the mixture using a 200-mesh filter.

The disclosed waterborne coating contains the ink-absorbing sphere emulsion and the inorganic ink-absorbing material, both of which are helpful to enhance ink absorption and improve printing quality.

The disclosed waterborne coating contains the reactive bridging agent. When the waterborne coating is made into a coating film or coating layer, the reactive bridging agent helps to net the high molecules, thereby significantly improving the coating film or coating layer in terms of water resistance and alcohol resistance, and eliminating the problems about fouling and scrapes when the coating film or coating layer is wet.

The acrylate monomer contained in the disclosed waterborne coating may be methyl methacrylate and butyl acrylate having hydrogen bonds, which help to enhance the acting power between the high molecules and increase binding between the inorganic ink-absorbing material and the resin, thereby significantly improving coating adhesion.

The disclosed waterborne coating, when applied to synthetic paper to form a coating film or a coating layer, endows the synthetic paper with improved coating adhesion, anti-fouling ability, solvent resistance, and scratch resistance as compared to similar products.

### EXAMPLES

### [Premade Emulsion of Ink-Absorbing Spheres]

### 1. Preparation of Emulsion-A

20 g of methacrylic acid (MAA), 40 g of methyl methacrylate (MMA) and 280 g of butyl acrylate (BA) were added into a container containing 60 g of de-ionized water and 1.5 g of sodium dodecyl benzene sulfonate, and stirred at high speed into a Mixture (I).

2000 g of de-ionized water and 60.4 g of Mixture (I) were placed into a reactor, stirred and heated to 78° C. To take 5 g of ammonium persulfate as an initiator was dissolved in 60 g of de-ionized water before putting into the reactor for reaction. After half an hour, the remaining of Mixture (I) was dropwise added in 1.5 hours, and the reaction was continued for 4 hours, to obtain an Emulsion-A having a pH value of 2.3, an average particle size of 170 nm and solid content of 13.5%.

### 2. Preparation of Emulsion-B

175 g of Emulsion-A and 1700 g of de-ionized water were added into a reactor, stirred and heated to 80° C.

490 g of methacrylate, 210 g of methyl methacrylate, 7 g of ethylene glycol dimethacrylate and 3100 g of de-ionized water were stirred at high speed into a Mixture (II). The Mixture (II) was dropwise added into the reactor in 3 hours.

8.4 g of ammonium persulfate as an initiator was dissolved in 70 g of de-ionized water and dropwise added into the reactor in 3.5 hours. After the dropwise addition of Mixture (II), the reaction was continued at 80° C. for 2 hours, to obtain an Emulsion-B having a pH value of 2.3, an average particle size of 324 nm and a solid content of 12.5%.

### 3. Preparation of Ink-Absorbing Sphere Emulsion

1350 g of Emulsion-B and 2200 g of de-ionized water were added into a reactor, stirred and heated to 80° C.

1000 g of styrene, 24 g of ethylene glycol dimethacrylate and 3 g of sodium dodecyl sulfate were stirred at high speed stir into a Mixture (III). The Mixture (III) was dropwise added into the reactor in 3 hours.

10 g of ammonium persulfate as an initiator was dissolved in 300 g of de-ionized water and dropwise added into the reactor in 3.5 hours. After the dropwise addition of Mixture (III), the reaction was continued at 80° C. for 1 hour. Afterward, the temperature was raised to 90° C., and 150 g of 9.3% ammonia was added. The mixture was cooled to and held at 86° C. for 2 hours, and then cooled to the room temperature. After the coagulation was filtered out, the ink-absorbing sphere emulsion having a pH value of 9.5, an average particle size of 856 nm, and a solid content of 24.4% was obtained.

### [Premade Waterborne Acrylate Emulsion]

### <Sample P1>

As shown in Table 1, 0.7 g of emulsifier SDS was added into a reactor containing 110 g of de-ionized water, continuously stirred and heated to 75° C. 30 g of de-ionized water, 56 g of butyl acrylate (BA), 5 g of methyl methacrylate (MMA), 36 g of styrene (ST), 5 g of acrylate acid (AA), 4 g of an emulsifier SDS were stirred at high speed into a Mixture (IV). 10 g of Mixture (IV) was added into the reactor, and stirred at 75° C. At the same time, 0.4 g of azodiisobutyronitrile (AIBN) as an initiator was dissolved in 10 g of de-ionized water and added into the reactor for reaction. After 10 minutes, the remaining Mixture (IV) was dropwise added in 4 hours. After the dropwise addition, the reaction was continued for 2 hours. Upon completion of the reaction, the mixture was filtered using a 200 mesh filter to obtain a waterborne acrylate emulsion P1.

### <Sample P2>

The reaction was performed like the Sample P1 taught, but the monomers used as shown in Table 1 were 56 g of butyl acrylate, 5 g of methyl methacrylate, 36 g of styrene, and methacrylic acid (MAA) 5 g. After reaction, the mixture was filtered using a 200 mesh filter to obtain a waterborne acrylate emulsion P2.

### <Sample P3>

The reaction was performed like the Sample P1 taught, but the monomers used as shown in Table 1 were 46 g of butyl acrylate, 10 g of methyl methacrylate, 46 g of styrene, and 1 g of acrylate acid (AA). After reaction, the mixture was filtered using a 200 mesh filter so as to obtain the waterborne acrylate emulsion P3.

### <Sample P4>

The reaction was performed like the Sample P1 taught, but the monomers used as shown in Table 1 were 72 g of butyl acrylate, 0.15 g of methyl methacrylate, 10.2 g of styrene, and 20 g of acrylate acid (AA). After reaction, the mixture was filtered using a 200 mesh filter to obtain a waterborne acrylate emulsion P4.

In each of the following examples and comparative examples, the coating layer was made on synthetic paper by applying the coating composition to a thickness of about 5 micron using a wire wound rod, drying the coating in an oven at 95° C. Afterward, the coating layer was tested using the following methods for its adhesion, anti-fouling ability, alcohol resistance, scrape resistance and printed color saturation.

### 1. Test for Adhesion

An adhesive tape is adhered to the coating, pressed using a 2 kg roller, and fast torn off from one end thereof to see whether the coating layer is damaged. In Table 2, “good” represents the coating is not damaged, while “poor” represents the coating is damaged.

### 2. Test for Anti-Fouling Ability

The coating with synthetic paper is immersed in purified water for 12 hours. Two such coated surfaces are pressed onto each other and dried in a convection oven at 35° C. After completely dried, the sample is visually observed to see whether fouling happens at the adhered surfaces. In Table 2, “good” represents the adhered surface has no fouling, while “poor” represents the adhered surface is fouling.

### 3. Test for Alcohol Resistance

The coating surface of the synthetic paper is wiped by a cotton swab moistened using alcohol concentration ranged from 20% to 95% for 10 times. The sample is visually observed to see whether the coating layer is damaged or pulled up, and the maximum alcohol concentration without damage to the coating layer is recorded.

### 4. Test for Solvent Resistance

The coated surface of the synthetic paper is wiped by a cotton swab moistened using acetone or cleaning naphtha for 10 times. The sample is visually observed to see whether the coating layer is damaged or pulled up, and record is made accordingly. In Table 2, “good” represents the coating layer is not damaged or pulled up, while “poor” represents the coating layer is damaged or pulled up.

### 5. Test for Scrape Resistance (Scratch Resistance)

The coated synthetic paper is immersed in purified water for one hour, and wiped using sandpaper on which a 500 g counterweight is placed for 10 times. The sample is visually observed to see whether the coating layer is damaged or pulled up. In Table 2, “good” represents the coating layer is not damaged, while “poor” represents the coating layer is damaged.

### 6. Assessment for Printed Color Saturation

The printed color saturation is measured using a color intensity meter TECHKON R410e conforming to DIN 16536 Standard for measurement of printed color intensity. The higher intensity is associated to the better printability.

### Example 1

As shown in Table 2, 4 g of the ink-absorbing sphere emulsion, 40 g of the waterborne acrylate emulsion P1 and 70 g of calcium carbonate were mixed. 0.68 g of crosslinker CX-100 from DSM (containing three aziridine functional groups) was added and stirred well. The mixture was filtered using a 200 mesh filter to obtain a waterborne coating W1.

The coating W1 was applied to a polypropylene synthetic paper (abbreviated as PP synthetic paper) using a coating rod, and baked at 95° C. for 15 seconds. After dried, the coating layer had a thickness of 5 μm.

The physical properties of the coating layer of the PP synthetic paper were tested, and the test results are shown in Table 2.

More specifically, the coating layer was tested by the adhesive tape for adhesion, and no peeling off observed. The sample was immersed in water, and tested for scrape resistance using 500 g-loaded sandpaper, and no pull-up observed. Two pieces of the sample were pressed on each other, dried, and tested for fouling. No fouling was observed. The maximum alcohol concentration without damage to the coating layer is 95%.

### Example 2

A waterborne coating W2 is prepared by the same process as the Example 1 taught, except that the waterborne acrylate emulsion P2 was used instead of the waterborne acrylate emulsion P1.

As shown in Table 2, the coating layer formed from the coating W2 was tested by the adhesive tape for adhesion, and no peeling off observed. The sample was immersed in water, and tested for scrape resistance using 500 g-loaded sandpaper, and no pull-up observed. Two pieces of the sample were pressed on each other, dried, and tested for fouling. No fouling was observed. The maximum alcohol concentration without damage to the coating layer is 95%.

### Example 3

A waterborne coating W3 is prepared by the same process as the Example 1 taught, except that the use amount of the ink-absorbing sphere emulsion was 5 g instead of 4 g as well as the use amount of crosslinker CX-100 was 0.3 g instead of 0.68 g.

As shown in Table 2, the coating layer formed from the coating W3 was tested by the adhesive tape for adhesion, and no peeling off observed. The sample was immersed in water, and tested for scrape resistance using 500 g-loaded sandpaper, and no pull-up observed. Two pieces of the sample were pressed on each other, dried, and tested for fouling. No fouling was observed. The maximum alcohol concentration without damage to the coating layer is 95%.

### Example 4

A waterborne coating W4 is prepared by the same process as the Example 1 taught, except that 70 g of the waterborne acrylate emulsion P3 was used instead of 40 g of waterborne acrylate emulsion P1; the use amount of the ink-absorbing sphere emulsion was 2 g instead of 4 g; the use amount of calcium carbonate was 26 g instead of 70 g; and the use amount of crosslinker CX-100 was 2 g instead of 0.68 g.

As shown in Table 2, the coating layer formed from the coating W4 was tested by the adhesive tape for adhesion, and no peeling off observed. The sample was immersed in water, and tested for scrape resistance using 500 g-loaded sandpaper, and no pull-up observed. Two pieces of the sample were pressed on each other, dried, and tested for fouling. No fouling was observed. The maximum alcohol concentration without damage to the coating layer is 95%.

### Example 5

A waterborne coating W5 is prepared by the same process as the Example 1 taught, except that 26 g of the waterborne acrylate emulsion P4 was used instead of 40 g of waterborne acrylate emulsion P1; the use amount of the ink-absorbing sphere emulsion was 3.5 g instead of 4 g; the use amount of calcium carbonate was 26 g instead of 70 g; and the use amount of crosslinker CX-100 was 0.5 g instead of 0.68 g.

As shown in Table 2, the coating layer formed from the coating W5 was tested by the adhesive tape for adhesion, and no peeling off observed. The sample was immersed in water, and tested for scrape resistance using 500 g-loaded sandpaper, and no pull-up observed. Two pieces of the sample were pressed on each other, dried, and tested for fouling. No fouling was observed. The maximum alcohol concentration without damage to the coating layer is 95%.

### Comparative Example 1

A waterborne coating W6 is prepared by the same process as the Example 1 taught, but neither ink-absorbing sphere emulsion nor crosslinker CX-100 was used.

As shown in Table 2, the coating layer formed from the coating W6 is fair in coating adhesion, scrape resistance and water resistance, but so poor in alcohol resistance, acetone resistance, cleaning naphtha resistance and printed color saturation. The maximum alcohol concentration without damage to the coating layer is only 20%.

### Comparative Example 2

A waterborne coating W7 is prepared by the same process as the Comparative Example 1 taught, except that the waterborne acrylate emulsion P2 was used instead of the waterborne acrylate emulsion P1.

As shown in Table 2, the coating layer formed from the coating W7 is fair in coating adhesion and scrape resistance, but so poor in alcohol resistance, acetone resistance, cleaning naphtha resistance, water resistance and printed color saturation. The maximum alcohol concentration without damage to the coating layer is only 20%.

### Comparative Example 3

A waterborne coating W8 is prepared by the same process as the Comparative Example 1 taught, except that 0.68 g of crosslinker SV-02 (containing three carbodiimide functional group) from An Fong Development Co., Ltd. was additionally used.

As shown in Table 2, the coating layer formed from the coating W8 is fair in coating adhesion and scrape resistance, but so poor in alcohol resistance, acetone resistance, cleaning naphtha resistance, water resistance and printed color saturation. The maximum alcohol concentration without damage to the coating layer is only 20%.

### Comparative Example 4

A waterborne coating W9 is prepared by the same process as the Comparative Example 1 taught, except that 0.68 g of crosslinker WD-726 from Mitsui Chemicals Inc. was additionally used.

As shown in Table 2, the coating layer formed from the coating W9 is fair in coating adhesion and scrape resistance, but so poor in alcohol resistance, acetone resistance, cleaning naphtha resistance, water resistance and printed color saturation. The maximum alcohol concentration without damage to the coating layer is only 20%.

### CONCLUSIONS

1. The disclosed waterborne acrylate of the present invention contains carboxyl functional groups, so can enhance the binding force of the ink-absorbing material, and increase acting force between molecules, thereby significantly improving coating adhesion.
2. The coating samples in Examples 1 and 2 were made with a crosslinker, so high molecules were netted in the resulting film, so as to significantly enhance the coating layer in terms of water resistance and alcohol resistance, and solve the problems about fouling and scrape.

Nevertheless, the crosslinker SV-02 (used in Comparative Example 3) containing three carbodiimide functional groups and the crosslinker WD-726 (used in Comparative Example 4) containing three isocyanate functional groups showed no obvious impact on fouling.
3. The present invention uses calcium carbonate, the ink-absorbing sphere emulsion and the acrylate emulsion to form the coating, and optimally arranges them in the order of particle sizes. After printed, the coating presents improved color saturation, and provides quick drying and good color fastness.
4. When compared to similar products, the disclosed waterborne coating is so suited for use in synthetic paper to significantly improve coating adhesion, water resistance (or called anti-fouling ability) and scratch resistance, and endows synthetic paper with good water resistance, good ink absorptivity, good printability and good color saturation when printed.

TABLE 1
Premade waterborne acrylate emulsion

| | | | Sample | | | |
|---|---|---|---|---|---|---|
| | | | Acrylate emulsion | | | |
| Component (in gram) | | | P1 | P2 | P3 | P4 |
| De-ionized water | | | 110 | 110 | 110 | 110 |
| Emulsifier (SDS) | | | 0.7 | 0.7 | 0.7 | 0.7 |
| Pre- | Purified water | | 30 | 30 | 30 | 30 |
| emulsion | Emulsifier | | 4.0 | 4.0 | 4.0 | 4.0 |
| | Monomer | Butyl | 56 | 56 | 46 | 72 |
| | A | Acrylate | | | | |
| | | (BA) | | | | |
| | Monomer | Methyl | 5.0 | 5.0 | 10 | 0.15 |
| | B | Methacrylate | | | | |
| | | (MMA) | | | | |
| | Monomer | Styrene (ST) | 36 | 36 | 46 | 10.2 |
| | C | | | | | |
| | Monomer | Acrylate | 5.0 | 0 | 1.0 | 20 |
| | D | Acid (AA) | | | | |
| | | Methacrylic | 0 | 5.0 | 0 | 0 |
| | | Acid (MAA) | | | | |

| | | | | |
|---|---|---|---|---|
| Solid Content | 40.2% | 39.6% | 40.0% | 40.1% |
| Tg (° C. ) | 38.2 | 40.1 | 39.2 | 39.5 |

TABLE 2
Waterborne coating composition and physical properties thereof

| waterborne coating | | Example | | | | | Comparative Example | | | |
|---|---|---|---|---|---|---|---|---|---|---|
| composition | | 1 | 2 | 3 | 4 | 5 | 1 | 2 | 3 | 4 |
| Acrylate emulsion (g) | | P1 | P2 | P1 | P3 | P4 | P1 | P2 | P1 | P1 |
| | | 40 | 40 | 40 | 70 | 26 | 40 | 40 | 40 | 40 |
| Ink-absorbing sphere | | 4 | 4 | 5 | 2 | 3.5 | — | — | — | — |
| emulsion (g) | | | | | | | | | | |
| Calcium carbonate (g) | | 70 | 70 | 70 | 26 | 70 | 70 | 70 | 70 | 70 |
| Crosslinker CX-100 (g) | | 0.68 | 0.68 | 0.30 | 2.0 | 0.5 | — | — | — | — |
| Crosslinker SV-02 ⁽¹⁾ (g) | | — | — | — | — | — | — | — | 0.68 | — |
| Crosslinker | | — | — | — | — | — | — | — | — | 0.68 |
| WD-726 ⁽²⁾ (g) | | | | | | | | | | |
| Physical | Adhesion | good | good | good | good | good | good | good | good | good |
| Property | Scrape resistance | good | good | good | good | good | good | good | good | good |
| | Resistance to | 95% | 95% | 95% | 95% | 95% | 20% | 20% | 20% | 20% |
| | alcohol | | | | | | | | | |
| | Resistance to | good | good | good | good | good | poor | poor | poor | poor |
| | acetone | | | | | | | | | |
| | Resistance to | good | good | good | good | good | poor | poor | poor | poor |
| | cleaning naphtha | | | | | | | | | |
| | Water | good | good | good | good | good | poor | poor | poor | poor |
| | resistance ⁽³⁾ | | | | | | | | | |
| | Printing color | 0.43 | 0.42 | 0.42 | 0.43 | 0.41 | 0.35 | 0.34 | 0.33 | 0.3 |
| | saturation (blue) | | | | | | | | | |

| | | | | | | | | | |
|---|---|---|---|---|---|---|---|---|---|
| Assessment if suited for | yes | yes | yes | yes | yes | no | no | no | no |
| use in synthetic paper | | | | | | | | | |

Note:
⁽¹⁾ The crosslinker SV-02 containing three carbodiimide functional groups is commercially available from An Fong Development Co. , Ltd.
⁽²⁾ The crosslinker WD-726 containing three isocyanate functional groups is commercially available from Mitsui Chemicals Inc.
⁽³⁾ The water resistance is also called the anti-fouling ability.

What is claimed is:

1. A waterborne coating for synthetic paper, based on a total weight of the coating, composed of components below summing up 100 wt %:
(1) an ink-absorbing sphere emulsion taking up 2-7 wt %;
(2) a waterborne acrylate emulsion taking up 26-70 wt %;
(3) an inorganic ink-absorbing material taking up 26-70 wt %;
(4) a waterborne crosslinker taking up 0.5-3 wt %;
wherein the waterborne acrylate emulsion (2) is primarily emulsion-polymerized from the following monomers (a)-(d) summing up 100 wt %:
(a) a low-Tg acrylate monomer taking up 45-70 wt %, being one or more selected from the group consisting of ethyl acrylate, n-propyl acrylate, n-butyl acrylate, isobutyl acrylate and isooctyl acrylate;
(b) a hydrophobic alkyl methacrylate monomer taking up 0.1-10 wt %;
(c) a hydrophobic styrene-based monomer taking up 10-45 wt %;
(d) a carboxyl-containing vinyl monomer taking up 1-20 wt %.

2. The waterborne coating for synthetic paper as defined in claim 1, wherein the component (2) of ink-absorbing sphere emulsion is produced by the following steps:
A) taking a weight ratio of a methacrylic acid (MAA) monomer to a methyl methacrylate (MMA) monomer is 1:2, adding therein a butyl acrylate (BA) as an acrylate-acid monomer with a use amount equal to 6-8 times by weight of the methyl methacrylate monomer, adding therein sodium lauryl sulfate as an anionic emulsifier with a use amount not exceeding 0.005 time by weight of the BA monomer, and performing emulsion polymerization to obtain an Emulsion A;
B) taking the Emulsion A, a MAA monomer with a use amount of 1-5 times by weight of the Emulsion A, and an acrylate-based monomer with a use amount of 1-4 times by weight of the Emulsion A, and adding ethylene glycol dimethacrylate in a use amount of 0.1-2 mol % of the total amount of the monomers, to perform an emulsion polymerization to obtain Emulsion B; wherein the acrylate-based monomer is one or more selected from the group consisting of methyl acrylate monomer, methyl methacrylate monomer, ethyl acrylate monomer, butyl acrylate monomer and 2-ethylhexyl acrylate monomer; and
C) taking the Emulsion B and a styrene (SM) monomer with a use amount of 0.5-1.5 times of Emulsion B for emulsion polymerization, and adding ammonia, to obtain an ink-absorbing sphere emulsion containing the Emulsion B up to 8.0-9.8% of the total solids content thereof.

3. The waterborne coating for synthetic paper as defined in claim 1, wherein the component (2) of the ink-absorbing sphere emulsion is a kind of acrylate micro-sphere having a particle size of 500-1100 nm.

4. The waterborne coating for synthetic paper as defined in claim 1, wherein the component (3) of the inorganic ink-absorbing material has a particle size of 1.2-5 μm and is one or more selected from the group consisting of calcium carbonate, titanium dioxide, diatomaceous earth, white clay, calcium oxide, silicon dioxide and barium sulfate.

5. The waterborne coating for synthetic paper as defined in claim 1, wherein the component (4) of the waterborne crosslinker has two or more reactive functional groups to bridge with carboxyl monomers and is one or more selected from the group consisting of isocyanate-containing crosslinker, epoxy-containing crosslinker and aziridine-containing crosslinker.

6. The waterborne coating for synthetic paper as defined in claim 1, wherein the hydrophobic alkyl methacrylate monomer is one or more selected from the group consisting of methyl methacrylate (MMA), ethyl acrylate (EA), propyl acrylate (PA), butyl acrylate (BA), isobutyl acrylate (IBA), amyl (meth)acrylate, hexyl methacrylate, heptyl methacrylate, 2-ethylhexylacrylate (2-HEA), n-octyl methacrylate, iso-octyl methacrylate (IOA), nonyl methacrylate (NA), sunflower methacrylate, lauryl (meth)acrylate (LA), octadecyl methacrylate, methoxyethyl (meth)acrylate (MOEA), n-butyl methacrylate (n-BMA), 2-ethylhexyl acrylate (2-EHA) and ethoxymethyl (meth)acrylates (EOMAA).

7. The waterborne coating for synthetic paper as defined in claim 1, wherein the hydrophobic styrene-based monomer is one or more selected from the group consisting of styrene monomer (SM), methylstyrene monomer (MSM) and vinyl toluene monomer.

8. The waterborne coating for synthetic paper as defined in claim 1, wherein the carboxyl-containing vinyl monomer is one or more selected from the group consisting of acrylic acid (AA), methacrylic acid (MAA), maleic anhydride (MA), fumaric acid (FA), itaconic acid (IA), butenoic acid (BA) and maleic anhydride (MAH).
